(19) United States
(12) Patent Application Publication
(10) Pub. No.: US 2006/0280575 A1
(43) Pub. Date: Dec. 14, 2006

(54) Programmable torque transmitter with spring element

(76) Inventor: Anton Ruettiger, Wildflecken (DE)

Correspondence Address: MCGRATH, GEISSLER, OLDS & RICHARDSON, PLLC, P.O. BOX 1364, FAIRFAX, VA, 22038-1364, US

(21) Appl. No.: 11/495,660

(22) Filed: Jul. 31, 2006

Related U.S. Application Data
(63) Continuation of application No. PCT/EP05/00757, filed on Jan. 26, 2005.

(30) Foreign Application Priority Data
Jan. 29, 2004 (DE) DE102004004762
Jan. 25, 2005 (DE) DE102005003593

(51) Int. Cl. F16B 13/04

(52) U.S. Cl. 411/15

(57) ABSTRACT

The present invention relates to an operating element for a motor vehicle, having a housing, a rotary knob, a rotary shaft arranged on the rotary knob, and a brake element engaging with the rotary shaft, by which an adjustable torque is transmitted to the rotary knob. An element exerting a spring effect is arranged between the rotary knob and the braking element such that a relative movement between the rotary knob and the braking element is achieved.

This nonprovisional application is a continuation of International Application PCT/EP2005/000757, which was filed on Jan. 26, 2005, and which claims priority to German Patent Application Nos. DE 102004004762 and DE 102005003593, which were filed in Germany on Jan. 29, 2004 and Jan. 25, 2005, respectively, and which are all herein incorporated by reference.

### BACKGROUND OF THE INVENTION

1. Field of the Invention

The present invention relates to an operating element for a motor vehicle, having a housing, a rotary knob, a rotary shaft arranged on the rotary knob, and a brake element engaging with the rotary shaft, by which an adjustable torque is transmitted to the rotary knob.

2. Description of the Background Art

Rotary actuators with adjustable force feedback are increasingly finding use in operating elements of motor vehicles. One possible way of setting and influencing the tactile sensation of a rotary actuator is for the rotary actuator to be braked by a magnetic field and a coil. As a result of this arrangement, it is possible to generate various braking torques at the rotary actuator as a function of current, and thus to set the adjustable detent or stop positions, or haptic characteristic curves, desired during rotation.

A rotary actuator of this nature is known from the U.S. Pat. No. 6,373,465 B2. Affixed to an end of an axle of the rotary knob is a circular disk, which is arranged between two magnetic field guides. These magnetic field guides, in turn, are designed as circular disks above and below the circular disk of the rotary knob. Via a coil arranged at the outer end of the circular disk of the rotary knob, a magnetic field can be generated with the aid of the magnetic field elements so that a braking torque can be applied to the circular disk of the rotary knob.

Also known, from DE 100 29 191 A1, which corresponds with U.S. Publication No. 2002057152, is an operating element with a rotary knob in which a gap between the rotary knob and the magnetic circuit is filled with a magnetorheological fluid. Via a coil and the magnetorheological fluid, an adjustable braking effect on the rotary knob can be induced here, as well.

Magnetorheological fluids (MRF) are substances whose viscosity changes as a result of the application of a magnetic field. They include, for example, of a carrier material in the form of water or oils mixed with iron filings or ferrites. The application of a magnetic field leads to an alignment of the magnetizable particles along the field lines. This results in a significantly altered viscosity of the substance. In a sufficiently intense magnetic field, the magnetorheological fluid behaves approximately like a solid material. An MRF rotary actuator includes a movable rotor which is located within a housing, wherein a narrow gap between the housing and rotor is filled with the magnetorheological fluid. In order to be able to produce a magnetic field of adequate strength in the gap between housing and rotor, the rotor is surrounded by a coil and a magnetically soft field guide. One problem with such rotary actuators is the clinging of the rotary actuator when it is not moved and a magnetic field is applied. This clinging, which is also referred to as a sticking effect and which resembles static friction, disrupts the force feedback of the established characteristic curve at every stop.

### SUMMARY OF THE INVENTION

It is therefore an object of the present invention to prevent a sticking at the detent edges of the individual detents of the rotary actuator, caused by the brake elements, that is typical of prior art rotary actuators with adjustable force/distance profiles.

The object of the invention is attained in that an element that achieves a spring action is introduced between the rotary knob and the brake element, so that a relative motion can be achieved between the rotary knob and brake element. Inserting a spring element between the brake element and the rotary knob now makes it possible to remove the sticking from the force feedback and eliminate it for the user; thus, sticking is no longer detectable by the operator of the rotary actuator.

An additional advantage of the invention is that it is now possible to detect the reverse motion out of a stop on account of the spring travel, which is to say the relative motion between the decoder and the stationary but activated brake element. When detecting reverse motion, the brake element is shut off in the case of small relative motion, which is to say with small and scarcely detectable application of force. The dynamic behavior of the torque transmitter is reinforced in a positive manner by the spring element when multiple detent positions are passed by.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a section through a rotary actuator equipped with a magnetorheological brake element;

FIG. 2 shows a section through a rotary actuator that is equipped with a magnetorheological brake element and an electromagnetic brake element and a torsion spring element; and

FIG. 3 shows a section through a rotary actuator that is equipped with a magnetorheological brake element and an electromagnetic brake element, a torsion spring element, and two separate encoder systems.

### DETAILED DESCRIPTION

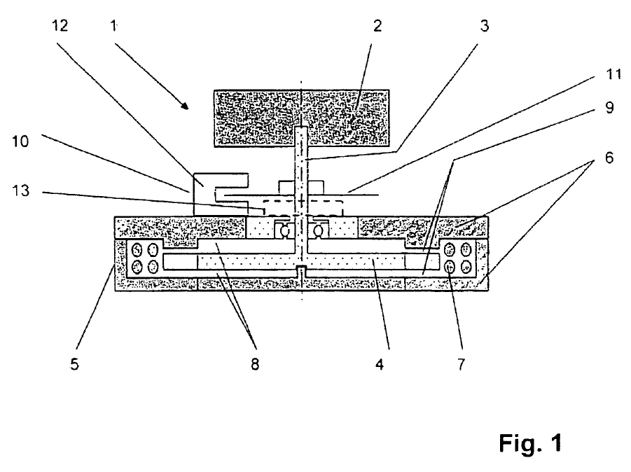

FIG. 1 shows a mechanical structure of a rotary actuator 1 without a torsion spring. Here, the rotary actuator 1 includes a rotary knob 2, an extension 3, a rotary shaft 3, a circular disk 4 located on the extension 3, and a housing 5 enclosing the circular disk 4. The housing 5 here is composed in part of magnetic field guides 6 made of soft iron. The coil 7 in this example embodiment is arranged in the shape of a circular ring around the circular disk 4. A magnetorheological fluid 8 (MRF) is located between the circular disk 4 and the housing 5. The radial surfaces 9 at the ends of the circular disk 4, together with the magnetic field guides 6, form the friction surfaces 9 for transmitting a frictional torque, where the term frictional torque is used as a synonym for static friction, braking torque, holding torque or comparable terms. It means that a braking force can be transmitted to the circular disk 4 by the magnetorheological effect.

Also located on the extension 3 of the rotary knob 2 is a device 10 for detecting rotational motion. The device 10 includes a disk 11 that is located on the extension 3 and can, for example, be provided with a bar code in the form of a prior art incremental distance measuring system (encoder disk), and can, for example, be analyzed by a light barrier 12; in this context, it is of course also possible to use multiple light barriers or a double light barrier system.

The direction of rotation can only be detected once a rotation has taken place at the rotary knob. Among other places, this makes itself noticeable at the stop, which is to say in the position in which the rotary knob 2 assumes its minimum or maximum position. During rotation into the stop, a high torque must be applied in the form of a braking torque in order to stop further rotation of the rotary knob 2 and indicate the end position to the operator. In contrast to a mechanical rotary actuator 1, this torque remains in effect even when the actuator is rotated back. Not until a position change has been detected at the rotary actuator can the torque be reduced. Reducing the stop torque after a defined period of time would have the result that, during rotation to the stop, the rotary knob 2 would abruptly jump a bit further each time this time period elapsed.

If a spring element 13 is now inserted in the rotary shaft 3 below the encoder element 10, 11, 12 in the rotary shaft 3, as shown in dashed lines in FIG. 1, a relative motion between the rotary knob 2 and the brake element can be achieved according to the invention. By means of this spring element 13, a relative motion can take place between the rotary knob 2 and the brake element, in this case the circular disk 4. For example, if the rotary knob 2 is located at a stop point, the circular disk 4 is stopped at this position by means of the magnetorheological brake element 4, 5, 6, 7, 8, so that the end stop is perceptible to the user of the rotary actuator 1. If the user now turns the rotary knob 2 out of this rest position, the rotary knob 2 is rotated together with the encoder disk 11. At this point, a relative motion occurs between the circular disk 4, which is locked at the stop, and the encoder disk 11. In the absence of the spring element 13, this locking of the circular disk 4 would be perceptible to the user in the form of sticking. Due to the inventively introduced spring element 13, it is now made possible to eliminate this sticking or locking of the circular disk 4 for the user. As a result of the rotary motion of the rotary knob 2 detected by means of the encoder disk 11, the rotary motion of the circular disk 4 is thus controllable.

Naturally, it is a matter of course here that different torsion spring elements 13 with different spring characteristics can be employed depending on the application case and the force feedback to be established in the rotary actuator 1. So, it is conceivable in particular for the spring element 13 to be implemented in the form of a torsion spring or a torsion rod or a torsion wire. Moreover, there is the possibility of producing the spring element 13 from a permanently flexible plastic material, such as rubber for example.

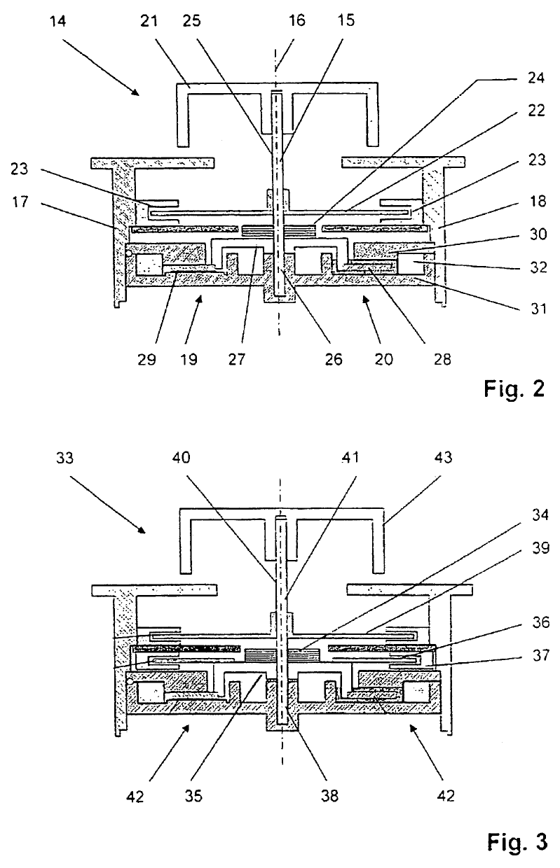

FIG. 2 shows another inventive design of an operating element 14 in the form of a rotary actuator 14. In this regard, FIG. 2 shows a cross-section through the rotary actuator 14 in side view. The components here are essentially rotationally symmetric in design. In the center of the rotary actuator 14, a center line 16 is drawn through a rotary shaft 15, dividing the rotary actuator 14 into two halves 17, 18. Each half 17, 18 contains a different brake element 19, 20. The first half 17 is equipped with an electromagnetically acting brake element 19. A magnetorheological brake element 20 is shown in the second half 18. This example illustrates that any brake elements 19, 20 can be used, with pneumatic, hydraulic, mechanical, or mixed forms of brake elements being equally usable here. The choice of brake elements here is arbitrary and can be made according to the force feedback and construction of the rotary actuator 14 to be produced.

In this connection, the rotary actuator 14 includes a rotary knob 21, the rotary shaft 15, and an encoder disk 22 that works together with a light barrier 23. A spring element 24 is integrated into the rotary shaft 15 below the encoder disk 22. Even though the rotary shaft 15 passes through the spring element 24 in this schematic view, the upper part of the rotary shaft 25 can rotate with respect to the lower part 26 of the rotary shaft 15. At the lower part 26 of the rotary shaft, an extension element 27 that is oriented radially outward is connected in a rotationally fixed manner to the lower part 26 of the rotary shaft 15. In this exemplary embodiment, a magnetizable element 28, 29 is arranged on each side 17, 18 of the extension element 27. In an actual embodiment of the rotary actuator 14, these magnetic or magnetizable elements 28, 29 would be implemented as circular rings, for example. The elements 28, 29 would then move as rotors 28, 29 in the magnetic fields of the electromagnetic brake element 19 or of the magnetorheological brake element 20.

In the absence of an applied magnetic field, the rotor 28, 29 here can rotate easily relative to the housing. In this case, no torque would be present at the rotary knob 21. After the application of a magnetic field, produced by the magnetic field guides 30, 31 and the coil 32, increased friction is achieved between the rotor 28, 29 and housing or magnetic field guides 30, 31, and is perceptible to the user as a torque or a detent at the rotary knob 21. Thus, any desired torque profile can be represented by means of angle-dependent alteration of the magnetic field, and thus of the friction between the rotor 28, 29 and the housing. It is possible, for example, to reproduce the profile that results from the use of a normal mechanical detent, which is to say a detent disk and springs. In this connection, various detent forms and torques can be represented by controlling the field strength of the magnetic field. The control unit here works with the measured values from the encoding system (encoder disk 22, light barrier 23) and the magnetic field controller, or these elements are combined in a common control unit. Thus, for example, combinations of fine detents and primary detents can be achieved, but also end stops where the friction is so high that rotation of the rotor 28, 29, and consequently of the rotary knob 21, is completely prevented.

Since, in contrast to a mechanical concept, the detent profiles in this form of a rotary actuator 14 can only be produced by electronic actuation, the rotary actuator 14 is freely programmable and can be provided with a wide variety of characteristic curves by means of the control unit.

In the choice of encoder, the rotary actuator 1, 14 is not restricted to an optical encoding system. Rather, it is also possible to implement alternative displacement measurement systems on an electronic or magnetic basis in the rotary actuator 1, 14. In particular, the use of an encoder disk 22 with varying slit widths is possible. In this context, the encoder disk 22 is arranged between an infrared emitting LED behind a diffuser and an infrared detector behind a converging lens. This makes it possible to convert the rotary motion of the rotary knob 2, 21 into an analog signal that in turn can be digitally analyzed by means of a processor. Due to the conversion of the analog signal into a digital signal, a much higher resolution can be produced than is possible with conventional systems having an encoder disk 11, 22 and light barrier 12, 23.

FIG. 3 shows another advantageous inventive example embodiment of a rotary actuator 33. The conceptual design corresponds to that of the rotary actuator 14, with an additional encoder disk being attached in a rotationally fixed manner to an extension element beneath the spring element 34. The extension element 35 here is essentially cylindrical in design, and the encoder disk 36 has the form of a circular disk. The encoder disk 36 works together with an additional light barrier 37. The lower encoder disk 36 is connected in a rotationally fixed manner to the lower region 38 of the rotary shaft 41, and the upper encoder disk 39 is connected in a rotationally fixed manner to the upper region 40 of the rotary shaft. In this way, it is now made possible to measure the relative motion between the brake element 42 and the rotary knob 43. The controller can determine a difference value from the difference between the rotary motions of the encoder disks 36, 39 and analyze it. It is thus possible to implement a control element in the rotary actuator 33 through a coupling of the two motions. As a result, the rotary actuator 33 is controllable.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An operating element for a motor vehicle, the operating element comprising:
a housing;
a rotary knob;
a rotary shaft arranged on the rotary knob; and
a brake element engaging with the rotary shaft, via which an adjustable torque is transmitted to the rotary knob,
wherein an element that achieves a spring action is provided between the rotary knob and the brake element so that a relative motion is achieved between the rotary knob and the brake element.

2. The operating element according to claim 1, wherein a device for detecting an angle of rotation and direction of rotation is arranged between the spring element and the rotary knob.

3. The operating element according to claim 1, wherein an electromagnetically or magnetorheologically functioning brake element acts on the rotary shaft.

4. The operating element according to claim 3, wherein an extension is formed on the rotary shaft and one part of the extension is a component of the electromagnetic or magnetorheological brake element.

5. The operating element according to claim 2, wherein an additional for detecting the angle of rotation and direction of rotation is arranged between the spring element and the brake element so a relative motion between the first and second devices for detecting the angle of rotation can be measured.

6. The operating element according to claim 2, wherein the device for detecting rotational direction and angle is an optical encoder.

7. The operating element according to claim 1, wherein the spring element is formed of a spring or a torsion spring,

8. The operating element according to claim 7, wherein the spring element is formed of a flexible plastic material.
